(19) United States
(12) Patent Application Publication
(10) Pub. No.: US 2018/0257339 A1
(43) Pub. Date: Sep. 13, 2018

(54) Architectural Resin Panel with Rust Layer and Methods for Making the Same

(71) Applicant: 3form, LLC, Salt Lake City, UT (US)

(72) Inventors: E. Egan Metcalf, Salt Lake City, UT (US); David J. Martin, Salt Lake City, UT (US); Matthew T. Sutton, Salt Lake City, UT (US)

(21) Appl. No.: 15/920,350

(22) Filed: Mar. 13, 2018

Related U.S. Application Data
(60) Provisional application No. 62/470,426, filed on Mar. 13, 2017.

(51) Int. Cl. B32B 9/04; B32B 3/30; B32B 5/16; B32B 37/00; C23C 22/50; C23C 22/78; B32B 15/09; B32B 15/18; B32B 27/10; B32B 27/36

(52) U.S. Cl. CPC B32B 9/045; B32B 2307/732; B32B 5/16; B32B 37/025; C23C 22/50; C23C 22/78; B32B 15/09; B32B 15/18; B32B 27/10; B32B 27/36; B32B 2250/03; B32B 2250/40; B32B 2264/102; B32B 2451/00; B32B 2307/414; B32B 2307/412; B32B 3/30

(57) ABSTRACT

A method of manufacturing a resin panel with a natural, oxidation flake layer comprises applying a solution to a material and allowing an oxidation flake layer to form, such as a rust layer on a metal sheet. A manufacturer can then layer the material with the oxidation flake layer and a thermoplastic substrate, so the thermoplastic substrate is facing the oxidation flake layer. A manufacturer can then heat the layers to the glass transition temperature of the thermoplastic substrate, causing the thermoplastic substrate to bond to the oxidized elements of the oxidation flake layer. The manufacturer can then separate the material from the thermoplastic substrate, thereby stripping the bonded oxidation flake layer away from the material where it remains embedded in the thermoplastic substrate. The resultant resin panel has a natural, translucent oxidation flake design, which can be used in both exterior and interior decorative and/or structural applications.

### CROSS-REFERENCE TO RELATED APPLICATIONS

This application claims the benefit of U.S. Provisional Application No. 62/470,426, titled ARCHITECTURAL RESIN PANEL WITH RUST LAYER AND METHODS FOR MAKING THE SAME, filed Mar. 13, 2017, which is incorporated herein by specific reference.

### BACKGROUND OF THE INVENTION

### 1. The Field of the Invention

The present invention relates generally to systems, methods, and apparatus for decorative architectural panels.

### 2. Background and Relevant Art

Recent architectural designs have focused on decorative laminate panel products, such as glass or laminate products, which can be used as decorative windows, and as partitions in offices and homes. In particular, decorative laminate panels are now particularly popular compared with decorative glass panels since decorative laminate panels can be manufactured to be more resilient, and to have the same appearance as glass but with less cost.

Present laminate products generally used for creating decorative laminate panels comprise polyvinyl chloride, acrylic, poly(methylmethacrylate) or “PMMA”, poly(ethylene-co-cyclohexane 1,4-dimethanol terephthalate) or “PETG”, as well as other related polycarbonate materials. Each of the aforementioned laminates can serve as an appropriate glass substitute. For example, polycarbonates, PETG, and PMMA are generally received for use in solid sheet form (i.e., extruded). An extruded sheet is generally a solid preformed sheet, such as a solid 4′×8′ PETG sheet (alternatively, 3′×5′ sheet, 5′×10′ sheet, etc.), which ultimately can form a surface of a decorative laminate panel when the panel is in final form.

Decorative laminate products (or “laminate products”, or “laminates”) more readily enable a recent trend of creating natural-looking decorative resin panel products. One example of a natural-looking resin panel product includes a panel showing a rust effect. A consumer, such as a homeowner or storeowner, may prefer to decorate a space using a laminate product that shows a rust effect, rather than using a rusted metal sheet, for a number of reasons.

For example, a rusted metal sheet degrades over time, thus changing or altering the rust aesthetic. Also, the rust on a metal sheet tends to transfer or rub off onto anything with which is comes into contact, reducing cleanliness. Furthermore, the homeowner or storeowner cannot easily clean rusted metal sheets without altering or changing the rust aesthetic due to the interaction between the rust and the cleaner. In contrast, laminate products that show a rust aesthetic (e.g., using a rust colored film layer) do not degrade or aesthetically change over time. Also, consumers can easily clean laminate products using household cleaners that do not change or impact the decorative aesthetic of the panel.

When creating panels with a rust effect, however, manufacturers have been limited to synthetic materials, like textiles or digital graphics, to imitate the look of rust. Such materials often readily appear to be unnatural, and can be less desirable. For example, a manufacturer using a digitally printed rust layer may have a difficult time imitating the randomness and uniqueness of a rust pattern that would form naturally on a metal sheet. On the other hand, using natural materials in this case can provide other, significant disadvantages.

For example, if manufacturers attempt to use rusted metal sheets within the resin layers to create products to create a more natural look, an adhesive layer generally might be required to enable sufficient bonding. Even then, the adhesive layer may not maintain its bond integrity with the metal sheet. To address bond strength, the manufacturer might need to use small metal sheets, or heavily perforated metal sheets, which allow sufficient resin-to-resin contacts for bonding.

One will appreciate, however, that such options may result an inferior product for a variety of other reasons. The weight of the metal layer alone could make the panel cost prohibitive both in terms of processing and shipping. In addition, the difficulties with bond strength can result in either a visually unappealing panel with multiple discontinuities (e.g., perforated, or segmented panes), or a panel that easily delaminates from the interlayer.

Furthermore, using one or more metal sheet layers blocks light transmission through the panel, thus limiting the aesthetic variety that a manufacturer can achieve by varying the opacity/transparency of the resin layers. For example, a consumer may have difficult with—or be outright prohibited from—using a back-lighting source to illuminate a panel having a metal sheet layer. Rather, the consumer may only have the ability to illuminate the rust layer on the metal sheet from the front.

Accordingly, there are a number of disadvantages in the art that can be addressed.

### BRIEF SUMMARY OF THE INVENTION

Implementations of the present invention solve one or more problems in the art with systems, methods, and apparatus configured to create an architectural panel with a natural oxidation layer, such as a rust layer, without necessarily requiring the use of corresponding material interlayers, such as the original metal sheet from which the rust was generated. In particular, in one implementation of the present invention, a decorative architectural resin panel has a flake layer made of rust particles stripped from an embedded metal sheet. The decorative architectural panel can include a first resin substrate, which has been subjected to heat and pressure, and oxidation flake elements, such as metallic rust elements, bonded to the resin substrate.

For example, at least one implementation of the present invention can comprise a decorative architectural resin panel having an interlayer comprising metal rust particles without a metal sheet embedded therein. In one implementation, the resin panel includes a first resin substrate comprising a thermoplastic sheet having been subjected to heat and pressure. The resin panel can also include a metallic rust layer bonded to the resin substrate, the metallic rust layer comprising oxidized metal flakes that have been stripped from a unitary metal sheet.

In addition, at least one implementation of the present invention can comprise a laminate assembly for use in preparing a translucent, thermoplastic resin panel comprising natural flake elements. The laminate assembly can include a treated metal sheet positioned about the first transparent resin substrate, the treated metal sheet comprising a flake layer. The first transparent resin substrate of about 1/32″ to about 2″ thick, and having a width of about 4′ wide and a height of about 8′, wherein the first transparent resin substrate is positioned directly against the flake layer of the oxidized metal sheet. The laminate assembly can further include a texture paper layer positioned against the first transparent resin substrate on a side opposite that of the metal sheet.

Furthermore, implementations of the present invention can comprise a method of manufacturing a resin panel with a rust layer. In one implementation, the method includes forming a rust layer on a metal sheet, and then transfer the rust layer to a thermoplastic substrate. The method can also include heating a layup assembly comprising the metal sheet with the rust layer and the thermoplastic substrate. In addition, the method can include subjecting the layup assembly to a temperature and pressure sufficient to allow the rust layer to bond to the thermoplastic substrate. Furthermore, the method can include removing the metal sheet after cooling, leaving the rust layer behind on the thermoplastic substrate as a decorative effect layer.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A shows a facing view of an exemplary resin panel with a rust layer in accordance with an implementation of the present invention;

FIG. 1B shows a perspective view of the resin panel shown in FIG. 1A;

FIG. 2A shows an exemplary metal sheet that has been treated to develop a rust layer in accordance with an implementation of the present invention;

FIG. 2B shows selected images resulting from various rust treatments applied to eight different metal sheets in accordance with an implementation of the present invention;

FIG. 3 illustrates an overview of a process for transferring the rust layer from a metal sheet to a resin substrate in accordance with an implementation of the present invention;

FIG. 4A shows an exemplary resin panel with a rust layer with a paper layer added to a layup assembly according to an implementation of the present invention;

FIG. 4B shows the resin panel shown in FIG. 4A with the paper layer partially removed after a process employing heat and pressure according to an implementation of the present invention;

FIG. 5 illustrates a flowchart comprising steps in a method for producing a resin panel with a rust layer in accordance with an implementation of the present invention;

FIG. 6A shows a rust pattern in a finished panel after processing has been completed in accordance with an implementation of the present invention; and

FIG. 6B shows another rust pattern in another finished panel after processing has been completed in accordance with an implementation of the present invention.

### DETAILED DESCRIPTION OF THE PREFERRED EMBODIMENTS

Implementations of the present invention extend systems, methods, and apparatus configured to create an architectural panel with a natural oxidation layer, such as a rust layer, without necessarily requiring the use of corresponding material interlayers, such as the original metal sheet from which the rust was generated. In particular, in one implementation of the present invention, a decorative architectural resin panel has a flake layer made of rust particles stripped from an embedded metal sheet. The decorative architectural panel can include a first resin substrate, which has been subjected to heat and pressure, and oxidation flake elements, such as metallic rust elements, bonded to the resin substrate.

One will appreciate that the processes and apparatus disclosed herein can create a more natural looking architectural panel than if materials like textiles or inks were used to imitate the look of real rust. Furthermore, because the manufacturer removes the metal sheet after transferring the rust layer to the thermoplastic substrate, the final weight of the architectural panel is reduced. In turn, the manufacturer reduces processing, shipping, and material costs.

In addition, a manufacturer can form the laminate product without the use of an adhesive, thereby allowing the manufacturer to process the resultant resin panel using direct bonds between substrate layers, and thereby providing sufficient bond strength. Direct bonding between resin substrates enables the substrates of the panel to more thoroughly interlock to achieve a unitary product, which resists delamination and ultimately is better suited to withstand weather when used exteriorly. One will appreciate that resin panels bonded to the rust interlayer without adhesives are more durable and tend not to delaminate easily. Thus, implementations of resin panels, according to implementations of the present invention, provide consumers with durable, long-lasting panels that do not break-up or deteriorate over time.

Along these lines, implementations of the resin panel with a rust layer include visual aesthetics that do not degrade or change over time. This is due at least in part since the thermoplastic materials of the resin panel do not oxidize/rust when exposed to certain environmental elements, such as water, unlike oxidizable materials such as steel or other metals. Thus, once a manufacturer forms the resin panel with the rust interlayer, and removes the metal sheet, no additional rust will form over time.

Also, the thermoplastic substrate layers of the resin panel provide a clean, clear barrier between an observer of the panel and the rust layer. Thus, the rust layer of the panel does not rub off or transfer to objects or persons with which it may come into contact. As such, a consumer, such as a homeowner or office/store owner, can clean the panel using cheap, common household cleaners without impacting the aesthetic appearance of the rust layer.

In addition, a manufacturer can form a wide range of aesthetic effects by customizing features of the rust layer during processing. Such customizable features can include the rust color, opacity, thickness, and size of the panel. Thus, the manufacturer can form the rust layer across various sizes of panels without discontinuities (e.g., perforated or segmented planes) to create a visually pleasing resin panel having a natural rust aesthetic. The manufacturer can create a random, unique, and natural looking pattern of corrosion (e.g., rust) in each panel by varying the motions, solutions, and patterns used to form the flake layer on the source material layer.

In addition, because no source material (e.g., metal sheet) is disposed between the resin layers, light can transmit at least partially through the flake layer (e.g., rust layer) as well as other transparent resin layers of the panel. Again, the manufacturer can vary the materials used and the amount of rust formed for the flake layer to vary the light transmission properties of the end-product. These variations can result in a wide range of opaqueness, allowing an end-user to back-light the panel or light it from the front to create different display effects.

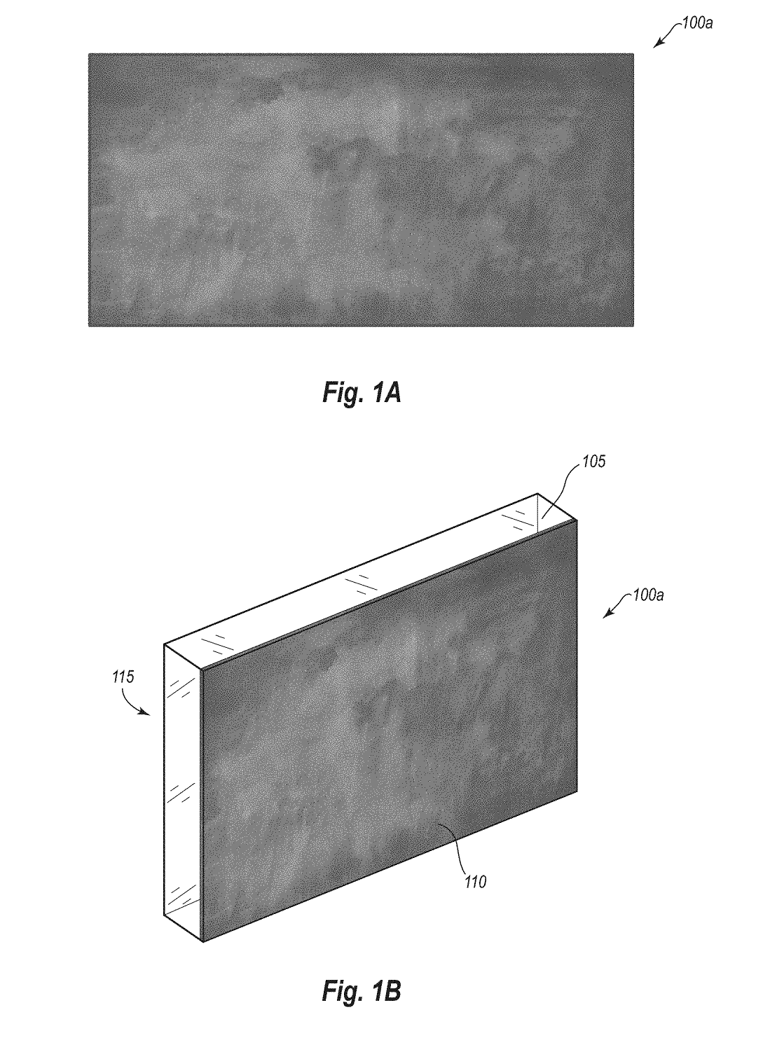

Referring now to the figures, FIGS. 1A and 1B illustrate an exemplary resin panel with a rust layer 100a. As shown in FIG. 1A, the rust layer creates a natural-looking design on the resin panel 100a. FIG. 1B shows a left side perspective view of the resin panel 100a that illustrates the width of the resin panel 100a. As shown in FIG. 1B, the resin panel includes at least two layers.

The present disclosure describes these layers in more detail below, but in general, the layers include a transparent or translucent thermoplastic substrate 105, and a flake layer (i.e., rust layer) 110 made up of oxidized metal, including oxidized metal flakes. In particular, the manufacturer can include a thermoplastic substrate 105 that is at least semi-transparent or translucent so that when one views the panel from a side 115 that does not include the rust layer 110, looking through the thermoplastic substrate 105, the rust layer 110 is visible. Thus, light can at least partially pass through one or both layers of the resin panel 100a, resulting in a resin panel 100a that displays the rusted/oxidized/corroded layer 110 in a simple and aesthetically pleasing way. Thermoplastic Materials

One will appreciate that the present invention is not limited to the embodiment shown in FIGS. 1A and 1B. Rather, implementations of the present invention are generally applicable to use of a wide range of resin panels, both planar and non-planar, of any size. The manufacturer may desire a resin panel with a non-smooth textured or embossed surface. The non-smooth, textured or embossed surface can provide additional decorative aspects to the surface of a resin panel, and also provide a further benefit in making surfaces more resilient in its display of mars or scratches that may occur during transport, installation or service of a resin panel construct.

In addition, the materials used for the thermoplastic layer 105 may vary between different embodiments. By way of explanation, and as understood more fully herein, any or all of the resin components in the thermoplastic layer/substrate can comprise any number of different resin materials, and/or combinations thereof. In one implementation, for example, thermoplastic substrate(s) 105 can comprise any one or more of polycarbonate materials, polyester materials (including copolyester materials), acrylic materials, and/or combinations thereof.

For example, for the purposes of this specification and claims, a polyester material refers to any one or more of PBT, PET, PETG, or PCTG, and combinations thereof. In addition, an “acrylic” material refers to PMMA or the like, whether in extruded form, or created through continuous casting, or mold-casting processes, and further includes impact-modified acrylic.

One will appreciate that thermoplastic sheets for use in accordance with the present invention can comprise a variety of sizes and gauges. For example, a manufacturer can employ thermoplastic sheets that are about 3′ by about 5′ in width, or about 4′ in width, which have a length of about 6′ by 10′, or about 8′. In addition, the manufacturer can employ thermoplastic sheets in a variety of gauges relevant to the desired thickness of the end product. For example, the manufacturer can employ thermoplastic sheets of about 1/32″, 1/16″, ⅛″, ½″, 1″, ⅕″, or 2″.

### Rusted Sheet Materials

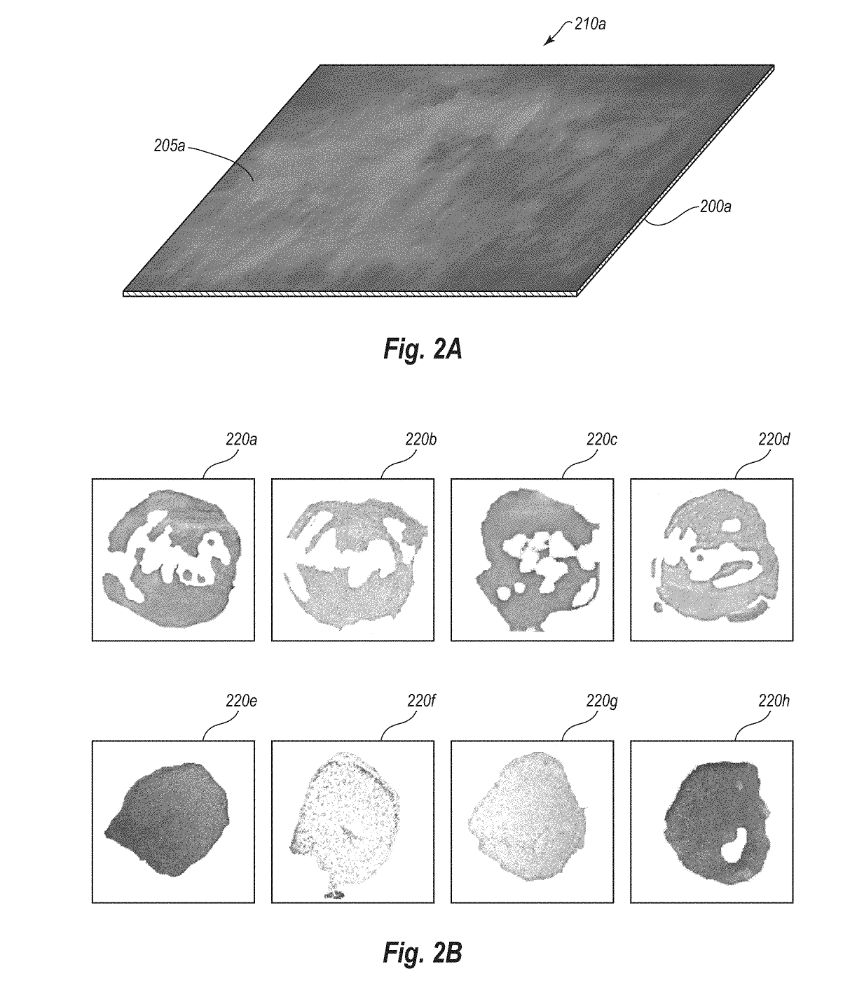

Initially, a manufacturer can form a “flake layer” that can be stripped from a particular material and embedded into a resin substrate. In one implementation, the flake layer 110 comprises an oxidation flake layer, created from a treated material (e.g., a metal sheet), before transferring the flake layer to the thermoplastic substrate 105. Along these lines, FIG. 2A illustrates an exemplary metal sheet 200a that has been treated to develop a rust layer 205a, resulting in a metal sheet with a rust layer 210a. The metal sheet 200a used to form the rust layer 205a is preferably a ferrous metal. Also, the metal sheet 200a can comprise steel that does not include any protective surface coating or surface barrier. Alternatively, a manufacturer can use other ferrous materials on which to form the rust layer 205a. For example, in one implementation, the metal sheet 200a comprises cast iron or wrought iron. In another implementation, the metal sheet 200a comprises carbon steel.

Generally, a manufacturer can use any material that can be chemically changed on a surface level to achieve a flake layer. As mentioned, at least one implementation comprises oxidizable metal sheets. Alternatively, a manufacturer can transfer layers formed on other corrodable (e.g., oxidizable) materials due to other forms of chemical treatment, including oxidation or other degradation processes. Such layers can include a silver-sulfide layer formed on silver due to its interaction with hydrogen sulfide. Another example includes copper patina formed from the oxidation of copper, as well as patina formed on bronze, other metals, and even wood or stone. Still further examples of flake layers comprise heated materials that generate a char layer on the surface, such as wood, or other organic matter.

### Rusting Compounds/Solutions

With specific reference to corrosion in the form of rust and oxidation, natural oxidation processes, including the oxidation of iron in steel, may require long periods of time. However, a manufacturer can treat a material (e.g., with certain oxidizing chemicals and/or solutions) to accelerate the formation of the flake layer comprising oxidized flake materials, such as rust layer 110. For example, chemical compounds such as hydrogen peroxide and sodium hypochlorite, accelerate the oxidation of iron when applied to a ferrous metal sheet. Also, for example, a manufacturer can apply hydrochloric acid to the metal sheet 200a to accelerate the rusting process.

In at least one implementation, the treatment of the metal sheet 200a includes applying a solution of hydrogen peroxide, vinegar, and sodium chloride to the metal sheet 200a and waiting for the solution to oxidize the metal in the metal sheet 200a. The oxidation process creates in this case oxidized metal flakes, illustrated as rust layer 205a.

In at least one implementation, an exemplary oxidation solution comprises a solution having a ratio X₁:X₂:X₃ of hydrogen peroxide:vinegar:salt by mass. For example, at least one solution of the present invention comprises X₁ in a range from about 190 to 195, and preferably about 192. The exemplary solution can further comprise X₂ in a range of from about 10 to 30, and preferably about 24, while X₃ can range from about 0.5 to about 1.5 or 2, and preferably about 1. The salt can comprise, for example, NaClO (sodium hypochlorite)

Another solution comprises a forge solution, which implements a pre-pickling step using vinegar having between about 5% to about 20% acetic acid, followed by a solution of ratio X₁:X₂:X₃ of hydrogen peroxide:vinegar:salt by mass. As before, the oxidizing solution can comprise X₁ in a range from about 190 to 195, and preferably about 192. The solution can further comprise X₂ in a range from about 10 to 30, and preferably about 24, while X₃ can range from about 0.5 to about 1.5 or 2, and preferably about 1.

If the solution does not dissipate and/or evaporate itself, the manufacturer may further use fans to accelerate drying. One will appreciate that a manufacturer may use any metal in accordance with an embodiment of the present invention (e.g., a steel sheet, a solid iron sheet, or other metal sheet comprising oxidizable metal). One will also appreciate that in additional or alternative implementations, the manufacturer could use any solution or means that causes a chemical change in the material, such as the above noted rusting of metal.

FIG. 2B illustrates eight sample metal sheets 220a-h patterns created using variations of the above-noted oxidation solutions for their oxidation/rusting effect. One will appreciate that varying the components and concentrations of the oxidizing solution can result in different aesthetic effects in the material. In particular, FIG. 2B illustrates various results consistent with changing the concentrations of the ingredients in the oxidizing solution, which can significantly change the color, amount, and concentration of flake (e.g., rust) produced. For example, metal sheet 220a comprises a pattern generated with an oxidizing solution having about a ratio 192:24:1 of hydrogen peroxide:vinegar:salt by mass. In particular, the exemplary oxidizing solution comprises X₁ in a range from about 190 to 195, and preferably 192. Also, the solution comprises X₂ in a range from about 10 to 30, preferably 24, while X₃ ranges from about 0.5 to 2, preferably 1.

Along these lines, the illustrated pattern of metal sheet 220b can be made by treating a metal sheet using an oxidizing solution having a ratio X₁:X₂:X₃ of hydrogen peroxide:vinegar:salt by mass at 192:12:0.5. Specifically, the solution can comprise X₁ at between about 190 and 195, preferably 192, X₂ between about 10 and 20, preferably 12, and X₃ at between about 0.1 and 1.5, preferably 0.5.

Similarly, the illustrated pattern of metal sheets 220c-h can be created from other concentrations. For example, the pattern of metal sheet 220c can be made from an oxidizing solution in a ratio of X₁:X₂:X₃ of hydrogen peroxide:vinegar:salt by mass, where X₁ can be between about 92 and 100, preferably 96, X₂ is between about 96 and 102, preferably 98, and X₃ is between about 1 and 8, preferably 4.

In addition, the pattern of metal sheet 220d can be made with an oxidizing solution that comprises a ratio X₁:X₂:X₃ of hydrogen peroxide:vinegar:salt by mass, where X₁ is between about 92 and 100, preferably 96, X₂ is between about 10 and 15, preferably 12, and X₃ is between about 1 and 8, preferably 4.

Furthermore, the pattern of metal sheet 220e can be made using an oxidizing solution made with a ratio X₁:X₂:X₃ of hydrogen peroxide:vinegar:salt by mass, where X₁ is between about 190 and 195, preferably 192, X₂ is between about 20 and 30, preferably 24, and X₃ is between about 1 and 5, preferably 2. Similarly, the pattern of metal sheet 220f can be made with an oxidizing solution having a component ratio X₁:X₂:X₃ of hydrogen peroxide:vinegar:salt by mass. In this case, X₁ is between about 92 and 100, preferably 96, X₂ is between about 20 and 30, preferably 24, and X₃ is between about 0.1 and 1.5, preferably 0.5.

Still further, the pattern of metal sheet 220g can be made with an oxidizing solution having a component ratio X₁:X₂:X₃ of hydrogen peroxide:vinegar:salt by mass of 192:12:0.5. In this case, X₁ is between about 190 and 195, preferably 192, X₂ is between about 10 and 15, preferably 12, and X₃ is between about 0.1 and 1.5, preferably 0.5. The solution a manufacturer used to create the pattern on the metal sheet 220g is substantially similar to the solution used to create the pattern on the metal sheet 220b, described above. That is, the manufacturer treated both metal sheets 220b, 220g with a solution having a ratio of about 192:12:0.5 hydrogen peroxide:vinegar:salt by mass.

Thus, the difference in appearance of these two patterns on metal sheets 220b, 220g can be due to the randomness with which a manufacturer applies the solution from one sheet to the next. Therefore, a manufacturer can vary the pattern with which the solution is applied to create a unique flake layer aesthetic on each metal sheet 220g, 220b, even when using the same solution or ratio thereof.

Meanwhile, the pattern of metal sheet 220h can be made with a solution having a component ratio X₁:X₂:X₃ of hydrogen peroxide:vinegar:salt by mass at 96:12:1. In particular, X₁ is between about 92 and 100, preferably 96, X₂ is between about 10 and 15, preferably 12, and X₃ is between about 0.1 and 1.5, preferably 1.

As such, one will appreciate that the manufacturer can use a wide variety of solutions, including various ratios of hydrogen peroxide, vinegar, and salt, to achieve a wide variety of aesthetic rust effects (e.g., metal sheets 220a-h of FIG. 2B). Additionally, a manufacturer can use ratios of the solution that fall anywhere in between the ratios described herein to adjust the color, concentration, density, and opacity of rust.

For example, a manufacturer can use a higher vinegar ratio, which results in a darker rust color. In the forge method, where vinegar is applied to the metal sheet 200a prior to the solution, the manufacturer can apply the vinegar to form dark streaks throughout the rust pattern. Furthermore, an increase in the ratio of hydrogen peroxide decreases the time it takes for the solution to dry, which impacts the amount of rust that forms.

Additionally, these various solutions and ratios thereof can be used alone or in combination with one another to achieve even greater aesthetic variety. For example, a manufacturer can apply the ratio and solution used to form the rust on metal sheet 220a to a first area of the metal sheet 200a and apply the solution and ratio of metal sheet 220b on another area, and so forth. As such, the manufacturer can customize the rust layer 205a as desired to accomplish any number of rust patterns or aesthetics.

Again, the manufacturer is not limited to the ratios and solutions described above. The manufacturer can apply a number of solutions to various other materials to form a flake layer. As described above, the flake layer can comprise oxidized iron on a metal sheet. However, the manufacturer can form a variety of layers and flakes on other materials using chemical solutions, compounds, and ratios thereof, as discussed above, either through oxidation reactions or other material degradation processes. For example, the manufacturer can apply a solution to oxidize a copper sheet and form a patina layer thereon. Also, for example, the manufacturer can form a silver-sulfide layer (or “tarnish” layer) by applying hydrogen sulfide to silver.

Method of Forming a Resin Panel having a Rust Layer

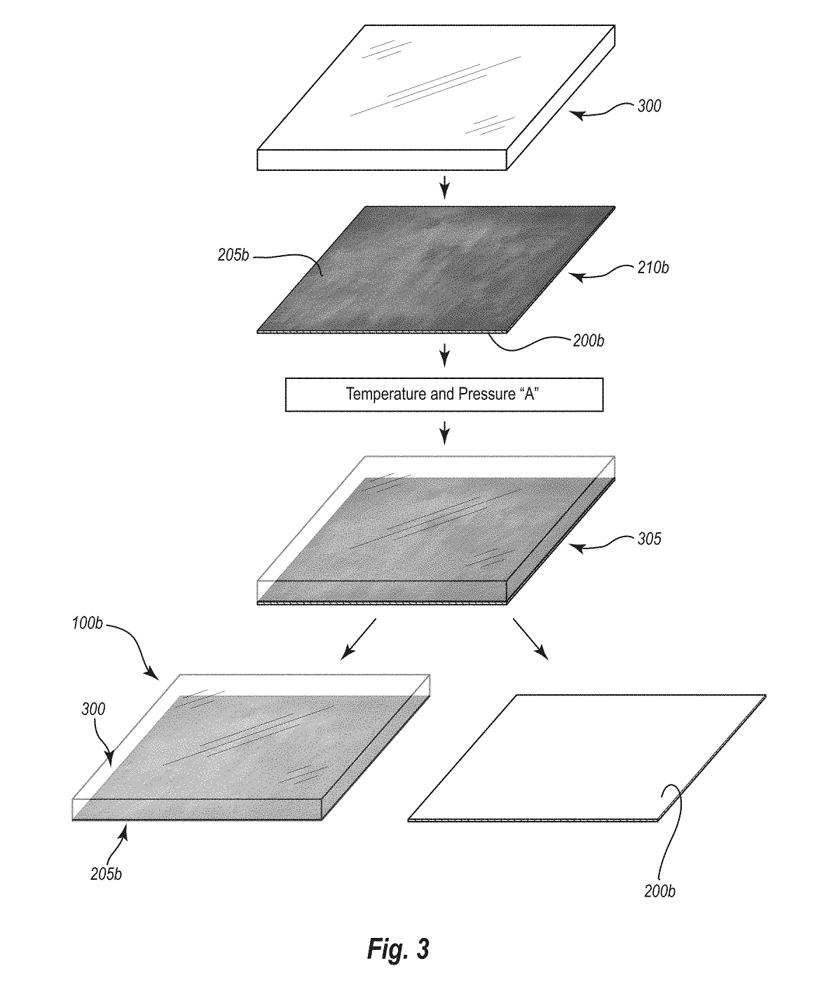

After the manufacturer forms the flake layer on a metal sheet, the manufacturer can transfer the flake layer from the metal sheet to bond with a thermoplastic layer of a resin panel. Accordingly, FIG. 3 illustrates a schematic overview of a process for transferring a flake layer 205b from the metal sheet 200b to a thermoplastic substrate 300 for use in accordance with an implementation of the present invention. The flake layer 205b of a ferrous metal comprises flakes of oxidized iron that a manufacturer can physically separate from the metal sheet 200b and transfer to the thermoplastic substrate 300

As shown in FIG. 3, a manufacturer can create a layup assembly or laminate assembly comprising a thermoplastic substrate 300 positioned to face the flake layer 205b of the treated metal 200b. One will appreciate that in additional or alternative implementations, the manufacturer can also include one or more adhesive films (e.g., PET, PMMA, or PVC adhesive films) or adhesive sprays.

FIG. 3 further shows that the manufacturer can affect the transfer of the flake layer 205b by subjecting the layup assembly to an appropriate forming temperature and sufficient pressure “A.” In general, the temperature and pressure used is sufficient to cause the glass transition temperature of the thermoplastic substrate 300 to be exceeded. The temperature and pressure parameters are particularly configured to allow the thermoplastic substrate 300 to melt and mechanically intertwine with the oxidized metal flakes comprising the flake layer 205b.

Finally, FIG. 3 shows that the manufacturer can remove the metal sheet 200b from the laminated panel 305, leaving a resin panel with an embedded flake layer 100b. This separation is possible because the surface energy of certain thermoplastics, such as PETG, is relatively high. Therefore, the flake layer 205b sufficiently bonds to the thermoplastic substrate 300 to allow the forces holding the flake layer 205b to the metal sheet 200b to be broken, thereby stripping the flakes (e.g., the rust flakes) from the source material (e.g., metal sheet) 200b.

This bonding of the oxidized metal flakes to the thermoplastic substrate 300, and subsequent separation from the metal sheet 200b, can also occur with flake layers of other materials, as described herein with reference to alternative implementations. For example, a manufacturer can bond flake layer formed as a char layer to the thermoplastic substrate 300 and remove the char layer from a charred material. Also, for example, the manufacturer can bond a flake layer formed as a patina on a copper sheet to the thermoplastic substrate 300 and subsequently remove the copper sheet. Likewise, a manufacturer can perform the same process using other flake surfaces of other materials.

One will appreciate that the layup assembly is not limited to that shown in FIG. 3. For example, the assembly can include more than one thermoplastic substrate 300 or metal sheet with a flake layer 210b. In this implementation, the flake layer can be a rust layer 205b. In at least one implementation, the manufacturer could use a metal sheet with a rust layer 210b that does not extend all the way to the edge of the thermoplastic substrate 300. The resultant resin panel with a rust layer 100b could also be further processed, such as laminating the resin panel with a rust layer 100b between thermoplastic substrates.

For example, a manufacturer can prepare a layup assembly or laminate assembly that includes the panel with rust layer 100b shown in FIG. 3 and an additional thermoplastic substrate. In this case, the manufacturer can arrange the additional thermoplastic substrate so that it contacts the rust layer 205b of the panel shown in FIG. 3. After preparing the layup/laminate assembly, the manufacturer can again subject the laminate assembly to heat and pressure, as described above with reference to the layup assembly shown in FIG. 3. The resulting resin panel with rust layer would include two thermoplastic layers having a rust layer 205b bonded therebetween. In such an implementation, a manufacturer can bond one or more additional thermoplastic layers to thermoplastic layers having other forms of flake layers bonded thereto, as described above. One will also appreciate that in one or more other implementations, a manufacture can form resin panels with rust layers that include more than two thermoplastic substrate layers.

Along these lines, a manufacturer can use two thermoplastic substrates that are the same or different materials, including thermoplastic substrates that vary in thickness, opacity, and color. In this way, the manufacturer can achieve a variety of aesthetic effects. For example, in one or more implementations of the method of forming the resin panel, as illustrated in FIG. 3 and described herein, the manufacturer can form the panel with one or more colored film layers bonded to the one or more thermoplastic resin substrates 300. Such colored film layers may comprise PETG, PVC, PCTG or other materials described herein.

A manufacturer can form any thermoplastic sheet substrate and colored film combination where the joining layers possess sufficient miscibility when combined via fusion at elevated temperatures. The manufacturer can utilize such a method for a panel system capable of multivariate colors. Such effective lamination may occur without a laminating enhancing layer or vacuum assistance so long as the highest glass-transition temperature (T_{g}) of the heterogeneous materials is exceeded during the lamination process, and the materials are sufficiently miscible so as not to result in hazing or insufficient bonding.

A manufacturer can thermally combine different colored films, ranging from 0.001″ to 0.030″ in thickness, more preferably in a range of 0.005″ to 0.020″ in thickness, and most preferably from 0.010″ to 0.015″ in total thickness, to make a single, uniformly colored panel assembly that includes a flake layer as well. The thermoplastic film layers may be positioned separately on the outermost surfaces of any clear thermoplastic substrate that is miscible with the thermoplastic film of any gauge, so long as the substrate is clear, transparent and has a clear or neutral color. Or, the thermoplastic films may be positioned conjointly on a single surface of the same substrate without significant change to the overall surface color of the panel assembly.

Furthermore, the manufacturer is not limited to transferring rust layers 205b to the thermoplastic substrate 300. Generally, a manufacturer can remove any type of flake layer formed on a material that bonds to the thermoplastic substrate according to the processes described herein. Such layers can include, or form on, any material that undergoes a chemical degradation or change that forms a surface layer of altered, removable surface material.

For example, burnt or charred materials such as wood or other organics may form a layer of ash, soot, or charcoal thereon, which a manufacturer can then transfer to a thermoplastic panel using the method described above. In particular, a manufacturer can use natural or biological materials, such as rocks, minerals, coral, wood, or various plants. These and other materials may also chemically or otherwise form flaky surfaces or loose facade layers to form the flake layer that a manufacturer can lift off and bind to a thermoplastic substrate. Also, some materials can grow flaky layers of mold, fungi, or other biological surfaces that a manufacturer can similarly bond to a thermoplastic substrate.

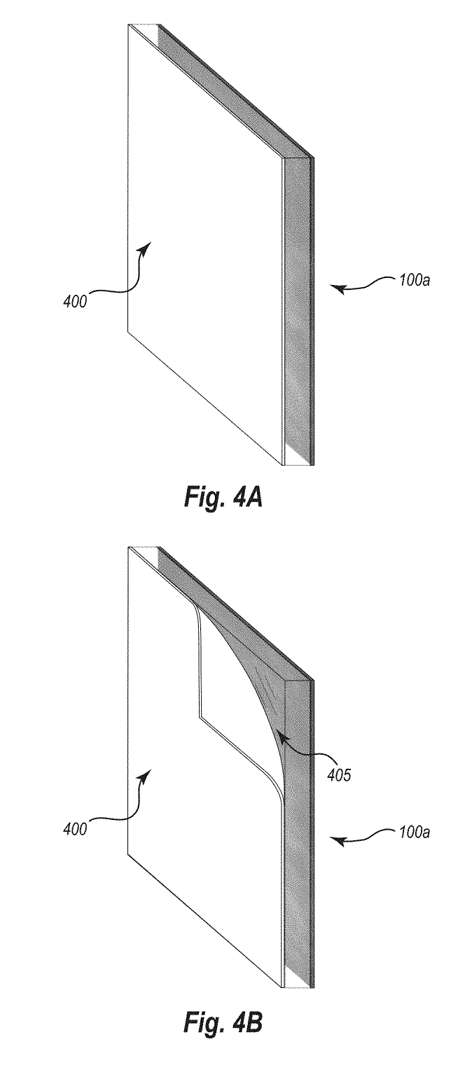

Additionally, a manufacturer can take steps to add textures to the thermoplastic substrate 300 during the process described above. For example, FIGS. 4A and 4B show an exemplary resin panel with a flake layer 100a and a paper layer (e.g., acrylic paper) 400 attached to the side of the thermoplastic substrate without the flake layer 405. The paper layer 400 can include textured elements, such as embossed patterns or other surface variations, which transfer to the thermoplastic substrate when heated past the glass transition temperature, as described above. As shown in FIGS. 4A and 4B, the manufacturer added a paper layer 400 to the layup/laminate assembly, placed on the side of the thermoplastic substrate without the flake layer 405. In this way, the manufacturer can add the textured elements of the paper layer 400 to the side of the thermoplastic substrate that is not bonded to the flake layer 405.

Preferably, the paper layer 400 comprises an adhesive surface (e.g., acrylic adhesive) on at least one side. The adhesive surface of the paper 400 is positioned facing toward the thermoplastic substrate 300, such that the adhesive surface will adhere to the thermoplastic substrate 300. As shown in FIG. 4B, the paper layer 400 will removably adhere to the resin panel with a rust layer 100a during the setting process, and can be peeled away from the thermoplastic panel 100a when the resin panel 100a is put to use. The paper layer 400 therefore provides a layer of surface finish to the side of the thermoplastic substrate without the rust layer 405.

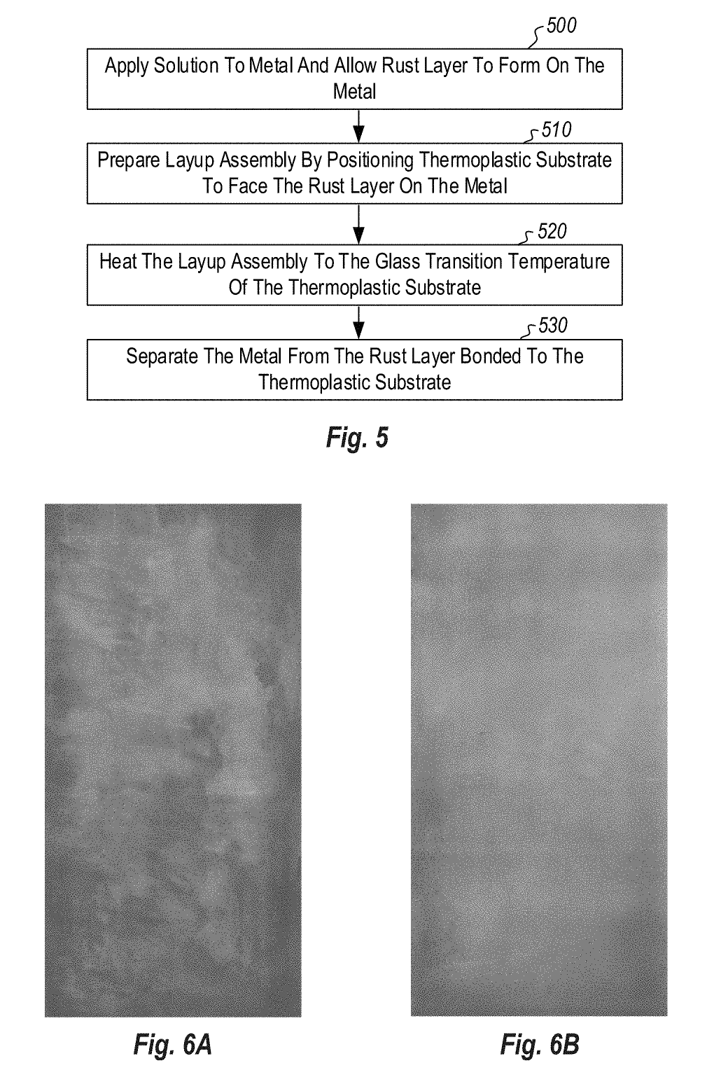

FIG. 5 illustrates a flowchart comprising steps in a method for producing a resin panel with a rust layer 100. As illustrated in FIG. 5, in at least one implementation of the present invention, a manufacturer may perform step 500 of applying a solution to a source material/metal sheet (e.g., a steel sheet, low carbon steel, a solid iron sheet, or other metal sheet comprising oxidizable metal, such as aluminum) to allow corrosion/rust to form on the material/metal sheet 500. In one or more alternative implementations, step 500 includes applying a solution to a material to allow a flake layer other than rust to form thereon. Other flake layers can include silver-sulfide, patina, char, or other flake layers described herein.

In addition, FIG. 5 shows that a manufacturer may then perform a step 510 of preparing a layup assembly by positioning a thermoplastic substrate to face the rust layer, or other flake layer, on the metal sheet 510. FIG. 5 further shows that the manufacturer can perform a step 520 of heating the layup assembly to the glass transition temperature of the thermoplastic substrate 520. This causes the thermoplastic substrate 300 in the assembly to flow and bond to the rust layer 205 of the metal sheet 200.

A manufacturer can vary the temperatures and pressures needed for bonding the rust layer 205 to the thermoplastic substrate 300 depending on the materials used. As noted above, in general, the temperature and pressure used is sufficient to cause the glass transition temperature of the thermoplastic substrate 300 to be exceeded. The temperature and pressure parameters are particularly configured to allow the thermoplastic substrate 300 to melt and mechanically intertwine with the flake layer, for example oxidized metal flakes comprising the rust layer 205b.

As an example, in one implementation, when using a PETG thermoplastic substrate 300, the manufacturer will subject the thermoplastic substrate 300 to a temperature between about 200 and 400 degrees-Fahrenheit. In another implementation, the manufacturer will subject a PETG thermoplastic substrate to a temperature between about 245 and 285 degrees-Fahrenheit. Preferably, a manufacturer will subject a PETG thermoplastic substrate to a temperature of about 265 degrees-Fahrenheit.

Also, as an example, in one implementation, when using a polycarbonate thermoplastic substrate 300, the manufacturer will subject the thermoplastic substrate 300 to a temperature between about 250 and 450 degrees-Fahrenheit. In another implementation, the manufacturer will subject a polycarbonate thermoplastic substrate to a temperature between about 320 and 380 degrees-Fahrenheit. Preferably, a manufacturer will subject a polycarbonate thermoplastic substrate to a temperature of about 350 degrees-Fahrenheit.

As a further example, in one implementation, when using an acrylic thermoplastic substrate 300, the manufacturer will subject the thermoplastic substrate 300 to a temperature between about 200 and 450 degrees-Fahrenheit. In another implementation, the manufacturer will subject an acrylic thermoplastic substrate to a temperature between about 250 and 400 degrees-Fahrenheit. Preferably, a manufacturer will subject an acrylic thermoplastic substrate to a temperature of between about 300 and 350 degrees-Fahrenheit.

The manufacturer can also select the pressure at which the thermoplastic substrate 300 is subjected. For example, in one implementation, the manufacturer can subject a PETG thermoplastic substrate to a pressure of between about 50 to 200 psi. In another implementation, the manufacturer can subject a PETG thermoplastic substrate to a pressure of between about 60 to 150 psi. Preferably, the manufacturer subjects a PETG thermoplastic substrate to a pressure of between about 65 and 100 psi.

Likewise, a manufacturer can use pressures that help achieve the glass transition temperatures of polycarbonate and acrylic materials, as well as other materials discussed herein. For example, in one implementation, when using acrylic, the manufacturer can subject the acrylic thermoplastic substrate to a pressure of between about 50 to 200 psi. In another implementation, the manufacturer can subject an acrylic thermoplastic substrate to a pressure of between about 60 to 150 psi. Preferably, the manufacturer subjects an acrylic thermoplastic substrate to a pressure of between about 65 and 100 psi.

As another example, in one implementation, when using polycarbonate, the manufacturer can subject the polycarbonate thermoplastic substrate to a pressure of between about 50 to 200 psi. In another implementation, the manufacturer can subject a polycarbonate thermoplastic substrate to a pressure of between about 60 to 150 psi. Preferably, the manufacturer subjects a polycarbonate thermoplastic substrate to a pressure of between about 65 and 100 psi.

Finally, FIG. 5 shows that the manufacturer can perform step 530 of separating the metal sheet from the rust layer bonded to the thermoplastic substrate 530. Because the oxidized metal flakes comprising the flake layer have mechanically intertwined with the thermoplastic substrate, the manufacturer can remove the metal sheet from the processed layup assembly leaving the rust layer bonded to the thermoplastic substrate. The resulting structure 100 is a decorative, architectural resin panel that can comprise any number of suitable designs and is suitable for any number of outdoor or indoor architectural purposes, and in particular without significant risk of delamination or damage to the embedded/laminated design.

### Example Steps for Creating Rust on a Metal Sheet

The manufacturer first gathers a new metal sheet for preparing for rusting. The manufacturer then creates a degrease mix ratio comprising the steps of mixing aircraft grade simple green with distilled water using a 1:1 ratio (concentrate:water) by volume in a spray bottle. The manufacturer can then perform the step of surface cleaning of the metal sheet. In one implementation, surface cleaning comprises placing a metal (e.g., steel) sheet on a clean flat surface underneath a vented hood, with the side to be rusted facing upwards.

The manufacturer then sprays the surface of the steel with degrease solution until fully coated and lets it soak for an appropriate amount of time. In one implementation, this time is about 60 s or more. In another implementation, this time is about 120 s or more. In yet another implementation, this time is between about 30 s and 60 s. The manufacturer can then wipe the surface with shop cloths to remove grease/degrease, dispose of the cloths as they become soiled, and continue applying degrease and wiping until no oil is removed by the cloth. The manufacturer can then obtain a sander, such as an orbital sander using sandpaper having a grit of about 220 or the like, and then sand the surface of the degreased metal sheet. In one implementation, the sand paper has a grit of between about 100 and 300. In another implementation, the grit of the sand paper is between about 200 and 250.

Sanding the surface of the degreased metal sheet creates a textured surface on which solutions used for forming rust can better settle and/or adhere. Also, sanding can create various aesthetic variations when forming rust on the surface of the metal sheet. Therefore, the manufacturer can use any variety of sand paper, including sand paper having various grits, either similar or different from the grits mentioned above, to customize the rusted metal sheet as desired.

### Forge Method

The manufacturer can then use one or more of at least two different techniques for initiate rust: a forge method, and an oxide method. Using the forge method, the manufacturer can in at least one implementation begin with a pickling process. In one implementation, the pickling process involves filling weed sprayer with distilled white vinegar and pump to induce pressure for spraying. The manufacturer then performs a focus spray in one or more strategic locations to induce rust features in a desired pattern, and by holding the spray nozzle about 1 ft above the surface of the sheet. In one implementation, the manufacturer decides where to spray in a random or semi-random fashion with each sheet. Alternatively, a template may be provide that the manufacturer generally follows. Furthermore, in another implementation, the manufacturer can use a physical stencil to ensure similar patterns and visual continuity between multiple rusted sheets.

In one implementation, the manufacturer applies the spray in a sweeping motion to avoid excess pooling. The manufacturer can weigh the weed sprayer before and after application to determine the amount of fluid deposited. In one implementation, when applying the spray to a 4×8 ft. sheet, the target fluid amount is between 55 g and 65 g, and preferably 60 g. This target amount decreases or increases in proportion with the size of the sheet.

The manufacturer can then measure an amount of distilled white vinegar, pour into a paint sprayer, and then spray an even coat across the sheet by holding spray nozzle 1 to 1.5 ft about sheet, moving the spray in a random sweeping motion. In one implementation, when using a 4×8 ft. sheet, the amount of distilled white vinegar is between 300 g and 500 g. In another implementation, the manufacturer uses between about 350 g and 450 g. Preferably, the amount of distilled white vinegar used for a 4×8 ft. sheet is about 400 g. The amount increases or decreases in proportion to the size of the sheet.

After roughly coating the sheet, the manufacturer can touch up areas that require additional solution until the full amount is used. After waiting an appropriate amount of time (e.g., 5 min after application) and then dry the metal sheet. In one implementation, the manufacturer waits for at least 10 minutes. In another implementation, the manufacturer waits at least 20 or 30 minutes. In one implementation, drying the sheet involves the manufacturer applying one or more fans per sheet to expedite drying. Drying time may vary depending on the size of the sheet and the amount of vinegar applied thereon, but generally lasts between about 20 and 40 minutes. Preferably, the manufacturer waits 30 minutes for the vinegar to dry. Ideally, the manufacturer waits for the solution to dry completely before moving to the next step in the process.

The manufacturer can then perform a series of steps in a rusting process. In one implementation, the manufacturer adds an effective amount of peracetic acid (or equivalent) rusting solution to a weed spraying vessel, and then pumps to apply pressure to the vessel. The manufacturer can then spray an even coating across the sheet using a back and forth motion. In one implementation, the manufacturer holds the spray nozzle approximately 1-1.5 ft about the metal sheet and applies the spray in a random sweeping motion to avoid patterning and excess solution pooling in localized areas.

The effective amount of peracetic needed for the metal sheet varies depending on the size of the sheet. In one implementation, when coating a 4×8 metal sheet, the manufacturer can use between about 300 g to 500 g of peracetic acid. In one implementation, the manufacturer can use between about 350 g and 450 g of peracetic acid, preferably about 400 g of peracetic acid. The effective amount of peracetic acid increases and decreases in proportion with the size of the metal sheet being treated

Once the full sheet is roughly covered, the manufacturer may provide touch up to areas that require it until the full amount of solution measured is deposited on the sheet. If there is excessive pooling on the panel, the manufacturer may use compressed air to spread fluid, such as by holding an air nozzle perpendicular to the sheet to spread the fluid evenly and avoid streaking.

The manufacturer can then wait a few minutes for the sheet to begin drying, upon which areas which require additional spraying will become apparent. The manufacturer can then apply a spray of peracetic acid (or equivalent) to lightly spray areas that are not rusting, or where the solution has dried too rapidly. The manufacturer can then wait a determined amount of time, for example, between about five to ten minutes, preferably eight minutes for the solution to react with the surface of the metal sheet.

The manufacturer can then dry the metal sheet, such as by using fans to expedite drying, and enabling the metal sheet to dry completely. In one implementation, the manufacturer waits between 20 and 40 minutes for the sheet to dry. In another implementation, the manufacturer waits between 25 and 35 minutes for the sheet to dry, and preferably for about 30 minutes for the sheet to dry. Furthermore, as needed after drying, the manufacturer may evaluate panel and touch up with spray bottle of peracetic acid (or equivalent) accordingly, and again allow to dry completely, and then repeat touch up as necessary.

### Oxidation Method

Additionally or alternatively, the manufacturer may implement an oxide method for instigating rust on a metal sheet. In at least one implementation, the manufacturer adds an effective amount of peracetic acid (or equivalent) rusting solution, such as those solutions described above, to a weed spraying vessel, and then pumps vigorously to apply pressure to the vessel. For example, for a 4×8 metal sheet, the manufacturer can use between about 300 g to 500 g of peracetic acid. In one implementation, the manufacturer can use between about 350 g and 450 g of peracetic acid, preferably about 400 g of peracetic acid. The effective amount of peracetic acid increases and decreases in proportion with the size of the metal sheet being treated.

The manufacturer can then spray an even coating across the sheet using a back and forth motion. To spray the coat across the sheet, the manufacturer holds the spray nozzle between about 1 and 1.5 ft above the sheet and applies the coat in a random sweeping motion to avoid patterning and excess solution pooling in localized areas. Once the full sheet is roughly covered, the manufacturer can then go back and touch up areas that require it until the full amount of solution measured is deposited on the sheet. If there is excessive pooling on the panel use compressed air to spread fluid. The manufacturer should generally take care to spread the fluid evenly and avoid streaking. Thereafter, the manufacturer can wait a few minutes for the sheet to begin drying. Areas which require additional spraying will become apparent.

For areas that are not rusting, or where the solution has dried too rapidly, the manufacturer can use the spray bottle of peracetic acid (or equivalent) to lightly spray areas that are not rusting or where the solution has dried too rapidly. The manufacturer can then wait an appropriate period of time for the solution to react with the surface of the metal sheet, as before, using fans to expedite drying. The appropriate period of time is generally at least 3 or 5 minutes, preferably 8 minutes. As with other steps, the manufacturer allows the metal sheets with applied solution to dry completely.

After drying, the manufacturer can evaluate the panel, and touch up the panel with a spray bottle of peracetic acid (or equivalent) accordingly. The manufacturer can then allow the metal sheet(s) to dry completely, and further repeat touch up as necessary. The drying time of the sheet(s), according to the oxide method, is similar to the drying time of the peracetic acid applied in the forging method described above. That is, in one implementation, the manufacturer waits between 20 and 40 minutes for the sheet to dry. In another implementation, the manufacturer waits between about 25 and 35 minutes for the sheet to dry, and preferably 30 minutes.

FIG. 6A shows a rust pattern in a finished panel after processing has been completed in accordance with an implementation of the present invention. In addition, FIG. 6B is shows another rust pattern in another finished panel after processing has been completed in accordance with an implementation of the present invention. As can be seen, the rust pattern showing through the thermoplastic surfaces provides a unique, brilliant pattern without necessarily requiring the embedment of a rusted metal sheet.

A manufacturer can create unique patterns for each resin panel created by varying a number of the steps and processes described above. For example, the manufacturer can increase the ratio of vinegar in a solution to create darker rust. Also, for example, the amount of solution the manufacturer applies in any of the steps described above, as well as the drying time and pattern of application, aesthetically impacts the end result of the rust layer.

As shown in FIGS. 6A and 6B, a manufacturer can include a thermoplastic layer that is at least semi-transparent or translucent so that when one views the panel from a side that does not include the rust layer, looking through the thermoplastic layer, the rust layer is visible. The different thermoplastic substrate materials described herein have different light transmission properties. Thus, light can at least partially pass through one or both layers of the resin panel, resulting in a resin panel that displays the rusted layer in a clean and aesthetically pleasing way.

In addition, because the panels do not include a solid/continuous metal sheet layer disposed between the resin layers, one can transmit at least partially through the rust layer as well as other transparent resin layers of the panel. Again, the manufacturer can vary the materials used and the amount of rust formed for the flake layer to vary the light transmission properties of the end-product. These variations can result in a wide range of opaqueness, allowing an end-user to back-light the panel or light it from the front to create different display effects.

Furthermore, as noted above, a manufacturer is not limited to flake layers in the form of rust from oxidized iron. A manufacturer can form a resin panel having other natural layers, any material that undergoes a chemical degradation or change that forms a surface layer of altered, removable flake material. For example, burnt or charred materials may form a layer of ash, soot, or charcoal thereon, which a manufacturer can then transfer to a thermoplastic panel using the method described above. Also, for example, a manufacturer can use natural or biological materials, such as rocks, minerals, coral, or other plants that may have other superficial flake elements that a manufacturer can lift off and bind to a thermoplastic substrate. Accordingly, one will appreciate in view of the present specification and claims that implementations of the present invention can be broadly applied to a wide range of materials to general resin panels with natural appearances obtained directly from those materials, and without necessarily having the disadvantages attendant from embedding the entire materials within the panels.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A decorative architectural resin panel, comprising:
an flake layer that has been stripped from a metal sheet; and
a first transparent resin substrate that has been subjected to heat and pressure, the first transparent resin substrate comprising a thermoplastic material having a thickness of between about 1/16″ to about 2″, a width of about 4′ and a length of about 8′;
wherein:
the flake layer is physically bonded to and embedded within the first resin substrate; and
the metal sheet has been removed from the flake layer and the resin panel.

2. The decorative architectural resin panel as recited in claim 1, further comprising:
a second resin substrate bonded to the first substrate and to the bonded flake layer.

3. The decorative resin panel as recited in claim 1, wherein the flake layer comprises flakes of oxidized iron.

4. The decorative resin panel as recited in claim 1, wherein the first resin substrate comprises a transparent PETG sheet.

5. The decorative resin panel as recited in claim 1, wherein the first resin substrate comprises PMMA.

6. The decorative resin panel as recited in claim 1, wherein the first resin substrate comprises polycarbonate.

7. The decorative resin panel of claim 1, further comprising:
a second resin substrate bonded to the first resin sheet about the side of the first resin sheet comprising the bonded flake layer;
wherein the second transparent resin substrate comprising a thermoplastic material having a thickness of between about 1/16″ to about 2″, a width of about 4′ and a length of about 8′.

8. The decorative architectural resin panel of claim 7, wherein the first and second resin substrates are non-planar.

9. A laminate assembly for use in preparing a translucent, thermoplastic resin panel comprising natural flake elements, comprising:
a treated metal sheet positioned about the first transparent resin substrate, the treated metal sheet comprising a flake layer;
a first transparent resin substrate comprising a thermoplastic sheet of about 1/32″ to about 2″ thick, and having a width of about 4′ wide and a height of about 8′, wherein the first transparent resin substrate is positioned directly against the flake layer of the treated metal sheet; and
a textured paper layer positioned against the first transparent resin substrate on a side opposite that of the metal sheet.

10. The laminate assembly as recited in claim 9, further comprising one or more colored film layers positioned against the first transparent resin sheet.

11. A method of manufacturing a translucent resin panel with a natural flake layer, the method comprising:
forming a flake layer on a material having a first side and a second side, the flake layer being formed on the first side, wherein the flake layer results from a chemical change to the material due to application of a solution and/or heat;
preparing a layup assembly comprising the material and a resin substrate, wherein the first side of the material comprising the flake layer faces the resin substrate;
subjecting the layup assembly to a temperature and pressure to allow the flake layer on the first side of the material to bond to the resin substrate; and
removing the material from the flake layer, thereby stripping at least a portion of the flake layer that is bonded to the resin substrate away from the material.

12. The method as recited in claim 11, wherein:
the material comprises a metal sheet, and
the flake layer comprises oxidized flakes formed by application of an oxidizing solution to the metal sheet.

13. The method as recited in claim 12, wherein forming the flake layer comprises:
spraying the first side of the material with degrease solution;
removing the degreasing solution; and
sanding the first side of the material.

14. The method as recited in claim 12, wherein forming the flake layer comprises a forge method, wherein the forging method comprises:
spraying the first side of the material with distilled white vinegar;
allowing the first side of the material to dry;
spraying the first side of the material with the oxidizing solution; and
allowing the first side of the material to dry.

15. The method as recited in claim 14, wherein the distilled white vinegar comprises about 6% acetic acid.

16. The method as recited in claim 12, wherein:
the oxidizing solution comprises ratio X₁:X₂:X₃ of hydrogen peroxide:vinegar: salt by mass,
wherein X₁ is between about 190 to about 195, X₂ is between about 10 and about 30, and X₃ is between about 0.5 to about 2.

17. The method as recited in claim 12, wherein the oxidizing solution comprises peracetic acid and wherein the method further comprises:
evenly spraying peracetic acid to the first side of the material;
lightly spraying areas of the first side of the material that dry to maintain the wetness of the first side for at least about 8 minutes; and
allowing the first side of the material to dry completely.

18. A method of manufacturing a translucent resin panel with an embedded natural rust layer obtained from a metal sheet, the translucent resin panel being devoid of the metal sheet, the method comprising:
treating a metal sheet to thereby create a prepared metal sheet having a first side having a rust layer, wherein treating the metal sheet comprises applying an oxidizing solution to the first side of the metal sheet and allowing a rust layer to form;
preparing a layup assembly comprising the prepared metal sheet with the rust layer and a first resin substrate, wherein the rust layer on the first side of the prepared metal sheet is facing the first resin substrate, and the first resin substrate comprises a transparent thermoplastic having a thickness of between about 1/32″ to about 2″, a width of about 4′, and a length of about 8′;
subjecting the layup assembly to a temperature and sufficient pressure to cause the resin substrate to exceed its glass transition temperature, thereby embedding the flake layer on the first side of the prepared metal sheet to bond to the first resin substrate; and
removing the metal sheet from the rust layer, thereby stripping at least a portion of the rust layer that is bonded to the first resin substrate away from the metal sheet.

19. The method as recited in claim 18, wherein the metal sheet comprises low-carbon steel.

20. The method as recited in claim 18, further comprising:
preparing a layup assembly comprising the first resin substrate and a second resin substrate, wherein the portion of the rust layer bonded to the first resin substrate is facing the second resin substrate; and
subjecting the layup assembly to a temperature and sufficient pressure to cause both the first and second resin substrates to exceed their respective glass transition temperatures, to thereby allow the rust layer on the first resin substrate to bond to the second resin substrate, such that the second resin substrate is bonded to both the rust layer and the first resin substrate.

21. The method as recited in claim 18, further comprising pickling the first side of the metal sheet with distilled white vinegar before the solution is applied to the first side of the metal sheet.

22. The method as recited in claim 18, wherein:
the solution comprises ratio X₁:X₂:X₃ of hydrogen peroxide:vinegar:salt by mass,
wherein X₁ is between about 190 to about 195, X₂ is between about 10 and about 30, and X₃ is between about 0.5 to about 2.
